(19) United States
(12) Patent Application Publication
(10) Pub. No.: US 2008/0034001 A1
(43) Pub. Date: Feb. 7, 2008

(54) Cell Phone Nutrition service

(76) Inventor: Loretta G. Noel, Johnson City, TN (US)

Correspondence Address: PITTS AND BRITTIAN P C, P O BOX 51295, KNOXVILLE, TN, 37950-1295, US

(21) Appl. No.: 11/835,410

(22) Filed: Aug. 7, 2007

Related U.S. Application Data
(60) Provisional application No. 60/821,626, filed on Aug. 7, 2006.

(51) Int. Cl. G06F 7/00

(52) U.S. Cl. 707/104.1

(57) ABSTRACT

A cellular phone-based nutrition information system. The cellular phone-based nutrition information system is designed to provide nutrition information to an end-user corresponding to the menu of a specified food service provider in order to allow the end-user to make informed decisions when ordering a meal through the use of a cellular phone communicating with a database providing nutrition information associated with food items offered by a food service provider.

### CROSS-REFERENCE TO RELATED APPLICATIONS

This application claims the benefit of U.S. Provisional Application No. 60/821,626, filed Aug. 7, 2006.

### STATEMENT REGARDING FEDERALLY-SPONSORED RESEARCH OR DEVELOPMENT

Not Applicable

### BACKGROUND OF THE INVENTION

1. Field of Invention

The invention relates to a nutrition information system accessible via a cellular phone network.

2. Description of the Related Art

Poor nutrition and diet is considered by many physicians, nutritionists, and government agencies to be a significant factor contributing to the increase of obesity in both children and adults. Nutritional analysis often involves meal planning, meal journals, and systems such as points. With our fast paced lifestyles, carrying books, calendars, calculators, and notebooks to record and sum up what we have eaten, or should eat, can easily get lost and forgotten. A busy schedule makes following a meal plan difficult and journaling one's meals is generally only useful after the fact to determine whether a good choice was made.

Presently, nutritional information is not readily accessible to persons on the go and, even when available, is often difficult to use in practice. While there are many books and recipe databases that can help determine nutrition information for a meal, those sources are generally too bulky and/or inconvenient to use outside the kitchens in our homes. Further, printed materials do not provide timely data and updating printed materials involves significant expense. Our fast-paced existence requires immediate and real time data. Even where a restaurant strives to provide nutritional information on a corporate level, the availability and currency of such information at an individual location varies and is, therefore, unreliable on a consistent basis.

In contrast, it is becoming less common for anyone to travel without a cellular phone. Cellular phones are popular tools for accessing content such as news, music, and video from almost anywhere. With the advent of the smart phone, the ability to store and access data has greatly improved. Currently, there even exists an application for nutritional analysis services. Embarq Telephone Company and independent nutritionists have developed a program designed to provide nutritional information via cellular phone. The Embarq program relies on information provided by the end-user in the form of photographs of the meal before it is eaten. Accordingly, the end-user is required to have a camera phone to use the service. Given the number of employers that, due to security and other concerns, ban cellular phones having cameras, this requirement eliminates many potential end-users. For those that do participate, a nutritionalist analyzes the photograph and responds to the user by providing a nutritional assessment of the meal; however, the turn-around time of the response is on the order of two-weeks. Thus, that meal and many others have been consumed before the end-user knows whether the meal was a good choice.

### BRIEF SUMMARY OF THE INVENTION

The nutrition information system allows an end-user having a web-enabled mobile client, particularly a cellular phone, running a mobile client application to communicate with a database system containing nutritional information. The query-response communications between the mobile client application and the database system allow a user-friendly menu system to be used to navigate through the food item choices associated with a particular food server provider using a limited input device, such as the keypad of a cellular phone. The end-user uses the mobile client application to select a food item or a group of food items and retrieve nutritional information for the meal. A web portal provides an interface between the mobile client application and the database system and provides enhanced access to administrative services from alternative devices, such as personal computers, having improved input devices such as full size keyboards and mice.

The nutrition information system is a modified client/server structure using a database as the workhorse for both maintaining client records as well as food information from food service providers. More specifically, the nutrition information system includes a mobile client operating on a communications network, a mobile client application, a database system storing nutritional information for various food service providers, and a web portal accessible through the internet for administrative functions related to the database system including subscription functions.

The mobile client connects to a communications network, thereby allowing nutrition information to be requested and received by the end-user. The mobile client runs a mobile client application that provides the user interface between the end-user and the database system. The mobile client application allows the end-user to enter a menu on mobile client and choose a food type such as “Fast Food” or “Restaurants.” Using the response from the database system, the mobile client application builds the list of available restaurants dynamically on the mobile client. The mobile client application then allows the end-user to choose the restaurant and food item through the use of successive menus. Once a food item is selected, the mobile client application requests and receives the nutrition information from the database system and displays the nutrition information for the end-user. The menu system is designed to be user-friendly allowing selections to be easily made with the limited keypad typically found on cellular phones. The menu system allows selections to occur in the form of standardized responses. The web portal provides customer service functions such as allowing end-users to enroll new accounts and make payments on current or delinquent accounts. The web portal also provides the interface between the mobile client application and the database system 108.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a block diagram of the nutrition information system; and

FIG. 2 is a flow diagram illustrating the functional interoperation of the components of the nutrition information system.

### DETAILED DESCRIPTION OF THE INVENTION

The cellular phone-based nutrition information system, or nutrition information system, 100 is designed to provide nutrition information to an end-user corresponding to the menu of a specified food service provider in order to allow the end-user to make informed decisions when ordering a meal through the use of a cellular phone communicating with a database providing nutrition information associated with food items offered by a food service provider.

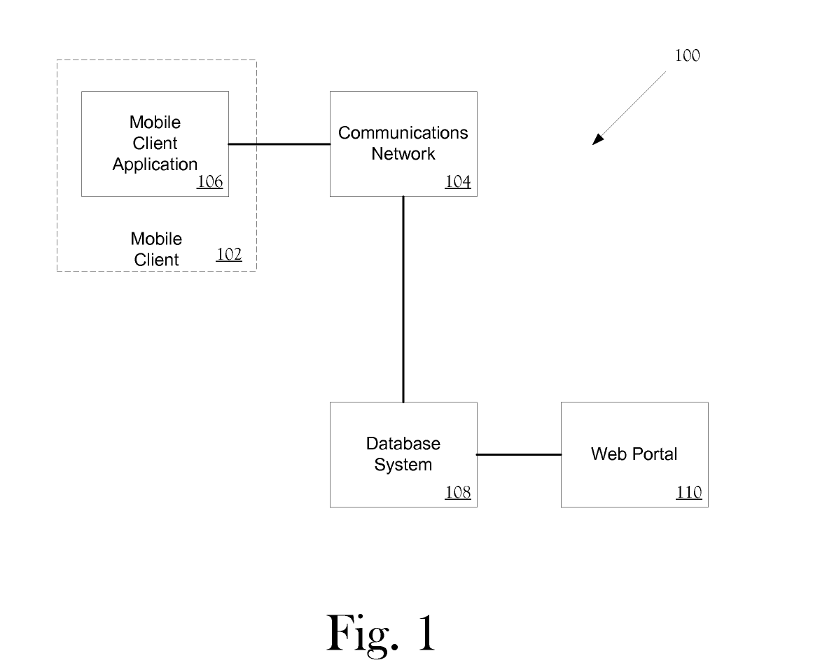

FIG. 1 illustrates a block diagram of one embodiment of the nutrition information system 100. The nutrition information system 100 is a modified client/server structure using a database as the workhorse for both maintaining client records as well as food information from food service providers. More specifically, the nutrition information system includes a mobile client 102 operating on a communications network 104, a mobile client application 106, a database system 108 storing nutritional information for various food service providers, and a web portal 110 accessible through the internet for administrative functions related to the database system 108 including subscription functions.

In one embodiment, the mobile client 102 is a web-enabled cellular phone. One skilled in the art will recognize other mobile clients that can be used without departing from the scope and spirit of the present invention. The mobile client 102 connects to a communications network 104, such as a cellular telephone network, thereby allowing nutrition information to be requested and received by the end-user. The mobile client 102 runs a mobile client application 106 that provides the user interface between the end-user and the database system 108. In a typical embodiment, the mobile client application 106 is downloaded to the mobile client 102 by the end-user or by the cellular service provider.

The mobile client application 106 relies on the cellular service provider supplying internet access to function properly. The mobile client application 106 allows the end-user to enter a menu on mobile client 102 and choose a food type such as “Fast Food” or “Restaurants.” Using the response from the database system 108, the mobile client application 106 builds the list of available restaurants dynamically on the mobile client 102. The mobile client application 106 then allows the end-user to choose the restaurant and food item through the use of successive menus. Once a food item is selected, the mobile client application 106 requests and receives the nutrition information from the database system 108 and displays the nutrition information for the end-user. The menu system is designed to be user-friendly allowing selections to be easily made with the limited keypad typically found on cellular phones. The menu system allows selections to occur in the form of standardized responses.

In one embodiment, the database system 108 operates on a clustered system architecture having a low maintenance design approach running a relational database management system application capable of storing and retrieving massive amounts of data regardless of data type. Various relational database applications exist and are suitable for use in the present invention including commercial offerings such as Oracle Enterprise and Microsoft® SQL Server Enterprise.

The web portal 110 offers a marketing and customer-service presence with low maintenance needs. The web portal 110 allows end-users to enroll new accounts and make payments on current or delinquent accounts. The web portal 110 also provides the interface between the mobile client application 106 and the database system 108.

A significant aspect of the nutrition information system 100 is the ability to provide nutrition information quickly so that the end-user can make an informed nutritional decision prior to ordering. By allowing the end-user to retrieve nutrition information for the available options at a food server provider, the nutrition information system 100 provides a convenient method of comparing meals. In one embodiment, the nutrition information system 100 offers the ability to provide a list of the “best” meals available for fast-food and formula restaurants, thereby narrowing the choices a health-conscious end-user must evaluate. In another embodiment, the nutrition information system 100 compiles the nutrition information on groups of food items and or specific combo meals available from the food service provider. This eliminates the need for the end-user to evaluate each food item separately in order to arrive at the total nutritional and diet data for a meal. In yet another embodiment, each time the end-user retrieves nutritional information for a food order, the nutrition & diet information is stored by date and time in the mobile client application 106 to create a personal menu planner, either automatically or by manual request. Finally, the nutrition information system 100 can incorporate mean plans, diet formulas, and nutrition ratings for various food items from weight control programs or diet programs desiring to integrate their services with the nutrition information system 100.

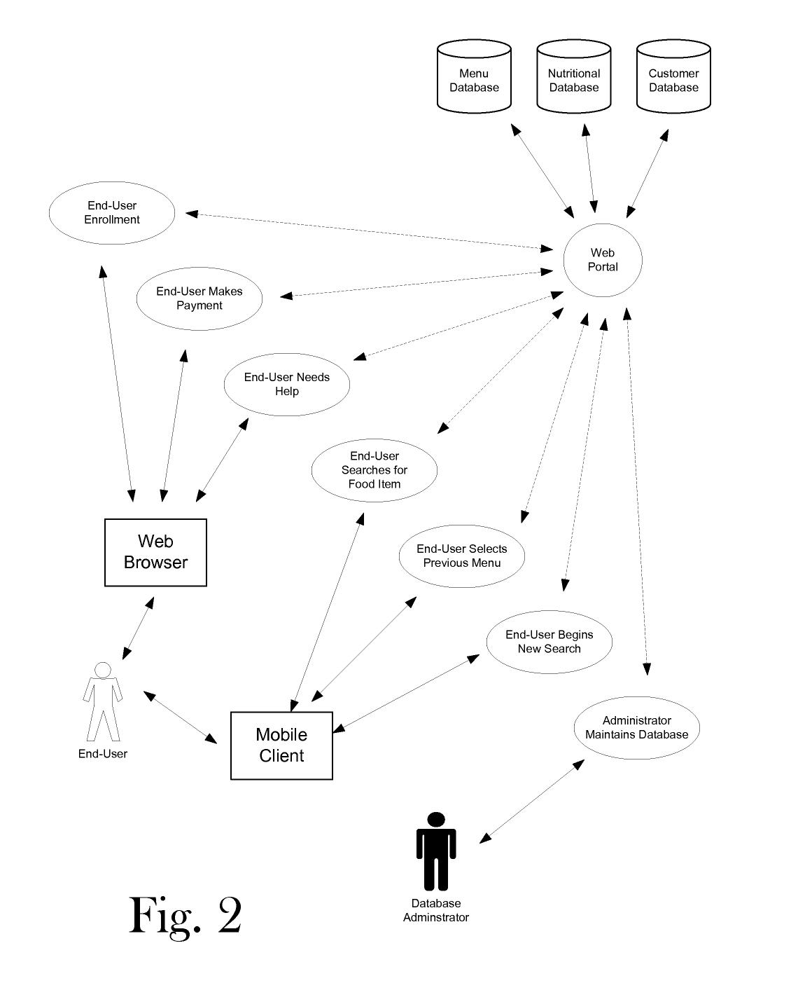

FIG. 2 is a flow diagram illustrating the operation of the nutrition information system 100. Use of the nutrition information system 100 requires a valid user account allowing the end-user to log in to the web portal 110. Access to the web portal 110 is accomplished using a web browser, which may be accomplished from the mobile client or another web-enabled device such as a personal computer. When the end-user navigates to the web portal 110, the nutrition information system 100 presents the end-user with a login screen that requests the end-user's login id and password. Assuming, the end-user already has an account and enters the login id and password combination, the nutrition information system 100 validates the combination against the authentication information in the customer database. If the login id and password combination is not correct, the end-user is notified and given an opportunity to correct the information. Until the end-user is authenticated, the nutrition information system 100 will deny access to the end-user.

If the end-user does not have an account associated with the nutrition information system 100, enrollment is required whereby a new end-user creates an account. In one embodiment, the enrollment process begins when the new end-user accesses the web portal 110 and initiates enrollment by selecting the enrollment option at the web portal 110. The nutrition information system 100 then asks the end-user to enter a login id and a password. The administrative portal validates the login id and password information against the authentication information in the customer database. If the login id is unavailable, for example, because the login id is already taken by another user or because the login id does not meet the validation criteria, the end-user is given another opportunity to select another login id. Similarly, if the password fails to meet validation criteria, the end-user is given another opportunity to select a valid password. Next, the nutrition information system 100 requests personal and billing information, including a valid phone number for system identification, from the end-user and associates that information with the end-user's account. The billing information includes the necessary information to access a funding source, such as a credit card account, an online payment service, or electronic funds transfer information. The valid phone number is typically the cellular phone number of the mobile client 102 from the end-user will access the nutrition information system 100. The system immediately verifies that the billing information is correct and the funding source is accessible and in good standing without charging the end-user. If the funding source cannot be accessed, the end-user is notified and given an opportunity to reenter billing information or select a new funding source. If the end-user is unable to provide a valid funding source that is accessible and in good standing, the nutrition information system 100 does not create an account. Otherwise, the nutrition information system 100 creates a new customer object and adds the customer to the customer database. After receiving confirmation from the end-user, the nutrition information system 100 transfer funds from the end-user's funding source for the balance on the account, updates the accounting records, and reports the status of the enrollment to the end-user. The end-user is also provided with the ability to select monthly auto-payment options.

The customer database is designed to store all data regarding billing, authentication, and verification for the end-users. This customer database is part of the server-side architecture of the nutrition information system 100. In one embodiment, the personal data stored in the customer database includes the name, social security number, phone number, and mailing address of the end-user. The customer database also stores financial information including the credit card type, credit card number, online payment service account number, payment history, current balance, statement cut date, payment due date, collections information, bank name, bank routing number, savings account number, checking account number, associated with the end-user. Further, the customer database stores status information such as the account suspension date, active/inactive status of the account. One skilled in the art will recognize that less information may be stored and/or additional information may be added to the customer database without departing from the scope and spirit of the present invention.

Periodically, an end-user must access the web portal 110 and make a payment to maintain continued access to the nutrition information system 100 using a valid funding source, which may be the same funding source selected at the time of enrollment or a different funding source. Making a payment requires the end-user log in to the web portal 110. When the end-user selects the “make payment” option at the web portal 110, the nutrition information system 100 requests personal and billing information and/or verifies personal and billing information associated with the end-user's account. When the billing information has not been saved, the nutrition information system 100 accepts input of the end-user's personal and billing information including a valid phone number for system identification and validates the information. If the funding source cannot be accessed, the end-user is notified and given an opportunity to reenter billing information or select a new funding source. Once a valid funding source is available, the nutrition information system 100 transfers funds from the funding source, updates the accounting records, and reports the status of the operation to the end-user. The end-user is then redirected to an appropriate page, such as a summary of the user account information.

In certain instances, the end-user may require additional information or assistance with the use of the nutrition information system 100. While logged in to the web portal 110, an end-user requesting help through a “help” option on the web portal 110 is presented with relevant information such a frequently-asked questions (FAQ) document or a prose document, such a policy statement. The nutrition information system 100 also presents interactive help features such as providing contact information by which the end-user may contact a customer service/support representative. In various embodiments, the contact information provided may include a phone number, a mailing address, an email address, or a web contact form, or any combination of these.

Moving beyond the administrative functions described above, the nutrition information system 100 provides the substantive function of providing nutritional information to the end-user upon request through a query-response communication protocol. When the end-user chooses to open a dialog with the information server for the purpose of requesting food information, the nutrition information system 100 queries the menu database and nutrition database as necessary to return the requested information. The request for nutrition information is initiated when the end-user opens the nutrition information system 100 software mobile client application 106 on the mobile client 102. In one embodiment, the mobile client application 106 option is provided as an option on a cell phone menu. The mobile client application 106 begins by initiating an internet gateway connection from the mobile client 102, if such connection is not already active. Next, the mobile client application 106 initiates a request to the server submitting cell number and possibly other identifying information. The database system 108 requests a lookup from the customer database using the phone number provided by the mobile client application 106 to make sure the end-user's account is in good standing. Provided that the end-user's account is in good standing, the database system 108 transmits a series of strings that are assembled by the mobile client application 106 on the mobile client 102 as a base menu, which in one embodiment is a list of food types. In one embodiment, the menu strings are stored in a menu database. The mobile client application 106 presents the food type menu to the end-user and awaits a selection by the end-user. In one embodiment, the food type menu includes categories such as “fast food,” “restaurant chains,” “unique,” and “kosher.” Upon a selection by the end-user, the mobile client application 106 sends normalized message, which corresponds to the menu choice, to the database system 108. The database system 108 queries the nutrition database for the names of the food service providers belonging to the selected food type and sends a list of new menu options and the process is repeated until a single meal or fast food item (combos included) is selected. In one embodiment, the food service providers are organized by region. In another embodiment, the food service providers are organized by an alphanumeric sort.

The nutrition database is designed to store all data regarding the content of food items as well as the classifications for that item such as food provider, and category. The nutrition database is part of the server-side architecture but the classes used to store retrieved data exist in both the server side and client architectures. In one embodiment, the nutrition database contains information about the food items including the food name, the food provider (i.e., the food service provider), the food category associated with the base menu strings, the food subcategory associated with secondary menu strings, and nutritional values including calories, calories from fat, total fat, saturated fat, trans isomer fatty acids, cholesterol, carbohydrates, sugars, protein, fiber, sodium, vitamin A, vitamin B6, vitamin B12, vitamin C, vitamin D, vitamin E, vitamin K, folic acid, zinc, magnesium, iron, calcium, and antioxidants. In one embodiment, the nutritional information is recorded in a consistent unit of measurement, e.g., grams, allowing U.S. daily recommend allowances to be derived by the mobile client application 106. One skilled in the art will recognize that less information may be stored and/or additional information may be added to the nutrition database without departing from the scope and spirit of the present invention.

The nutrition information system 100 provides error handling for typical connectivity and communication problems. If the mobile client application 106 cannot access the internet the mobile client application 106 reports failure to the end-user and advises the end-user to check internet connection and server status. If the database system 108 cannot authenticate the request, the database system 108 sends a normalized error message to the client which is reported to the end-user as an authorization restriction. If the database system 108 cannot communicate with the mobile client application 106, the database system 108 starts timers and/or counters and continues to attempt sending the requested information until a maximum attempt limit/time is reached after which the request is deconstructed, and the connection is terminated.

The query-response communication between the mobile client application 106 and the database system 108 is designed to facilitate corrections or changes to the request by the end-user through the use of dedicated keys. For example, the mobile client application 106 recognizes when the end-user presses the “back” button while in a dialog after making at least one menu choice and rebuilds the currently displayed menu from the last menu string collection so as to present the end-user with the previous menu options. A user selects the new search button when a food item is found. The mobile client application 106 also recognizes a “start” button which returns the end-user to the base menu. Thus, when the end-user is in a dialog after making at least one menu choice, i.e., having left the base menu, the mobile client application 106 rebuilds the menu to the base menu, either from stored menu strings or by requesting the database system 108 to send the base menu strings. After rebuilding the menu, the mobile client application 106 presents the end-user with the base menu in order to start a new food item search.

The menu database stores all data used to assemble menus and is part of the server-side architecture. The associated data class provides a structure for menus that allows the previous menus to be recalled. The menu database includes the menu name, the menu category, and a collection of menu options associated with the menu category. One skilled in the art will recognize that less information may be stored and/or additional information may be added to the menu database without departing from the scope and spirit of the present invention.

In addition to the functions intended for the end-user, the nutrition information system 100 includes administrator functions related to the information content that is made available to the end-user. The nutrition information system 100 provides the database administrator with the ability to add, delete, or query information from the database. To access the administrator functions, the database administrator logs in, is authenticated to the database system 108, and manually interfaces the nutrition database. By using database commands, queries, imports, and/or exports, the database administrator adds a food provider or food content information to the nutrition database, updates erroneous food content information stored in the nutrition database, modifies the architecture of the database, and/or tunes the database for increased performance. Such maintenance is routinely performed for reliable operation of the nutrition information system 100 and to expand the information available to the end-user.

A nutrition information system has been shown and described. The nutrition information database allows an end-user having a web-enabled mobile client, particularly a cellular phone, running a mobile client application to communicate with a database system containing nutritional information. The query-response communications between the mobile client application and the database system allow a user-friendly menu system to be used to navigate through the food item choices associated with a particular food server provider using a limited input device, such as the keypad of a cellular phone. The end-user uses the mobile client application to select a food item or a group of food items and retrieve nutritional information for the meal. A web portal provides an interface between the mobile client application and the database system and provides enhanced access to administrative services from alternative devices, such as personal computers, having improved input devices such as full size keyboards and mice.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants general inventive concept.

Having thus described the aforementioned invention, what is claimed is:

1. A nutrition information system operating on a cellular service network for retrieving nutrition information about food items associated with a food service provider, said nutrition information system comprising:
a database system having at least one database storing customer information, menu information, and nutrition information, said customer information including a phone number as a unique identifier, said nutrition information including food items associated with a food service provider and nutritional information associated with said food items, said database system returning selected information upon receipt of a request;
a mobile client application adapted to run on a cellular phone, said mobile client application adapted to generate a dynamic menu using menu information retrieved from said database system, said mobile client application adapted to display said dynamic menu, said mobile client including an input device, said dynamic menu providing at least one option selectable using said input device, said mobile client application generating said request and forwarding said request to said database system over the cellular service network, said mobile client application receiving said selected information from said database system and displaying said selected information, and
a web portal providing an interface between said mobile client application and said database system, said web portal comprising a plurality of web pages presenting outputs to and receiving inputs from an end user.
